(19) United States
(12) Patent Application Publication
(10) Pub. No.: US 2017/0232975 A1
(43) Pub. Date: Aug. 17, 2017

(54) SITUATION AWARENESS IN A VEHICLE

(71) Applicant: Panasonic Automotive Systems Company of America, Division of Panasonic Corporation of North America, Peachtree City, GA (US)

(72) Inventor: MICHAEL T. BURK, TYRONE, GA (US)

(73) Assignee: Panasonic Automotive Systems Company of America, Division of Panasonic Corporation of North America

(21) Appl. No.: 15/423,046

(22) Filed: Feb. 2, 2017

Related U.S. Application Data
(60) Provisional application No. 62/294,196, filed on Feb. 11, 2016.

(51) Int. Cl. B60W 50/14

(52) U.S. Cl. CPC B60W 50/14; G01S 19/13

(57) ABSTRACT

An interaction system for a vehicle includes a human machine interface controller coupled to a plurality of interface components that communicate information to a driver of the vehicle. The interaction system also includes a situational awareness module coupled to the human machine interface controller. The situational awareness module is configured to monitor driver and vehicle conditions, generate a comprehensive driving conditions status, and communicate the comprehensive driving conditions status to the human machine interface controller using a specified protocol.

### CROSS-REFERENCED TO RELATED APPLICATIONS

This application claims benefit of U.S. Provisional Application No. 62/294,196 filed on Feb. 11, 2016, the disclosure of which is hereby incorporated by reference in its entirety for all purposes.

### FIELD OF THE INVENTION

The present invention generally relates to computing systems in a vehicle. More specifically, the present invention relates to a system architecture for integrating situation awareness in a Human-Machine Interface (HMI) of a vehicle.

### BACKGROUND OF THE INVENTION

This section is intended to introduce the reader to various aspects of art, which may be related to various aspects of the present invention, which are described and/or claimed below. This discussion is believed to be helpful in providing the reader with background information to facilitate a better understanding of the various aspects of the present invention. Accordingly, it should be understood that these statements are to be read in this light, and not as admissions of prior art.

Vehicles, such as cars, trucks, SUVs, minivans, among others, can have various systems that receive and respond to various input and provide information to the driver. For example, a vehicle safety system may have a number of sensors that receive information about the driving conditions of the vehicle, environmental conditions, driver status, and others. Such systems may be configured to alert the driver to potential hazards. Many vehicles have navigation systems which may display a user's location on a map, provide turn-by-turn directions, among other functionalities. An infotainment system may enable the driver to render various types of media, such as radio broadcasts, recorded music, and the others. Vehicles usually also have an instrument cluster that includes a speedometer, fuel gauge, odometer, various warning lights, and other features.

### SUMMARY OF THE INVENTION

An exemplary embodiment can include an interaction system for a vehicle. The example system includes a human machine interface controller coupled to a plurality of interface components of the vehicle and that communicate s information to a driver of the vehicle. The system also includes a situational awareness module coupled to the human machine interface controller. The situational awareness module is configured to monitor driver and vehicle conditions, generate a comprehensive driving conditions status, and communicate the comprehensive driving conditions status to the human machine interface controller using a specified protocol. Optionally, the situational awareness module can receive input from an Advanced Driver Assistance System of the vehicle, one or more sensors configured to monitor a driver of the vehicle, and/or an antenna subsystem of the vehicle. In some examples, the situational awareness module receives input about the vehicle's surroundings to generate the comprehensive driving conditions status.

Optionally, the human machine interface controller can include an interface that receives the comprehensive driving conditions status from the situational awareness module and makes the comprehensive driving conditions status available to a plurality of software services operating on the human machine interface controller. For example, the human machine interface controller can include a personalization service that receives the comprehensive driving conditions status. The output of the human machine interface controller can be customized to a particular driver based in part on the comprehensive driving conditions status.

In another exemplary embodiment, a method for user and vehicle interaction can include receiving input from vehicle sensors for monitoring driver and vehicle conditions, generating a comprehensive driving conditions status based on the input, and communicating the comprehensive driving conditions status to a human machine interface controller using a specified protocol. The human machine interface controller is coupled to a plurality of interface components of the vehicle that communicate information to a driver of the vehicle The example method also includes generating a user interaction output at the human machine interface controller based in part on the comprehensive driving conditions status.

Another exemplary embodiment can include a vehicle for interaction with a user. The vehicle for interaction with a user includes an ignition system a plurality of sensors to acquire data about driver and vehicle conditions, and a processor. The processor is to monitor driver and vehicle conditions based on the data acquired by the sensors and generate a comprehensive driving conditions status based on the monitoring. The processor is also to communicate the comprehensive driving conditions status to a human machine interface controller using a specified protocol. The human machine interface controller is coupled to a plurality of interface components of the vehicle that communicate information to the driver.

### BRIEF DESCRIPTION OF THE DRAWINGS

The above-mentioned and other features and advantages of the present invention, and the manner of attaining them, will become apparent and be better understood by reference to the following description of one embodiment of the invention in conjunction with the accompanying drawings, wherein:

FIG. 1 is a drawing of an example system for a vehicle showing an HMI controller coupled to a situational awareness monitor (SAM).

FIG. 2 is a block diagram of an HMI controller in communication with the SAM.

FIG. 3 is a diagram of the SAM showing the various types of driving condition information that may be collected and processed by the SAM.

FIG. 4 is a process flow diagram summarizing an example method for an interaction system to operate for a vehicle.

Correlating reference characters indicate correlating parts throughout the several views. The exemplifications set out herein illustrate a preferred embodiment of the invention, in one form, and such exemplifications are not to be construed as limiting in any manner the scope of the invention.

### DETAILED DESCRIPTION OF THE PREFERRED EMBODIMENTS

One or more specific embodiments of the present invention will be described below. In an effort to provide a concise description of these embodiments, not all features of an actual implementation are described in the specification. It should be appreciated that in the development of any such actual implementation, as in any engineering or design project, numerous implementation-specific decisions may be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

The present disclosure describes a situational awareness monitoring system for a vehicle. As explained above, vehicles often have various systems that receive and respond to various input and provide information to the driver, including vehicle safety systems, navigation systems, infotainment systems, instrument clusters, and others. Each of the systems may at times compete for the driver's attention. Furthermore, each of these systems is usually isolated, with little or no communication between the systems.

The present disclosure describes a system architecture that enables several vehicle systems to be integrated. The architecture includes a Human-Machine Interface (HMI) controller that controls several or all of the various systems that are used to interact with the driver. For example, the HMI controller may be configured to control the instruments cluster, infotainment system, navigation system, audio system, and others. The HMI controller may be equipped with a number of software services, each of which may pertain to some aspect of the human machine interface.

The architecture also includes a situational awareness monitor (SAM) that monitors a broad range of driving conditions. The situational awareness monitor receives input data from various monitoring devices, processes and interprets the input data, and generates an output that pertains to some aspect of the present driving conditions. The output is sent to the HMI controller using a defined communications protocol that can be interpreted by each of the software services executing on the HMI controller. Accordingly, each of the human-machine interface systems has access to the same driving condition information and can respond in a coordinated manner. In this way, information can be presented to the user in a much more user friendly way that enables the user to focus on driving.

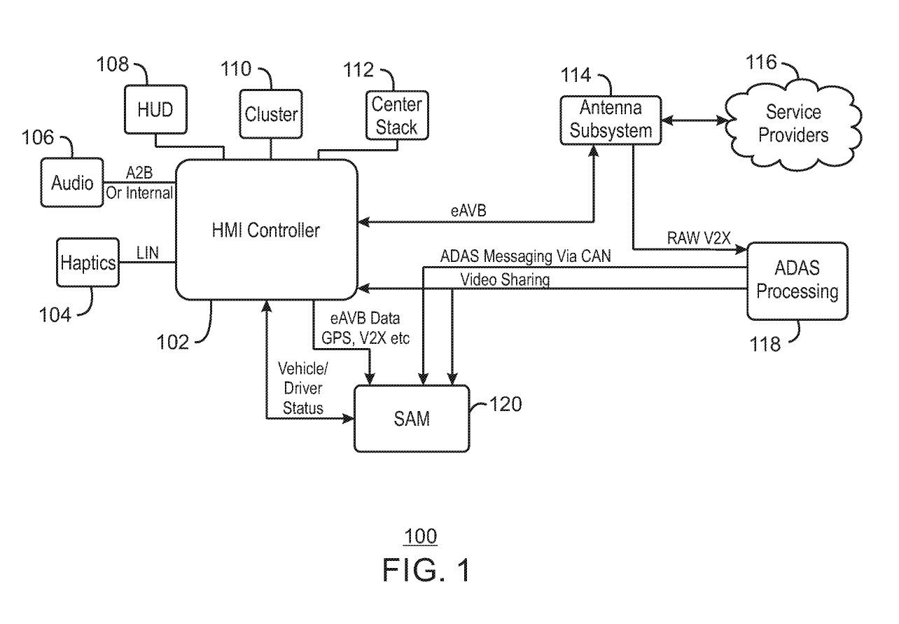

FIG. 1 is a drawing of an example system for a vehicle showing an HMI controller coupled to a situational awareness monitor (SAM). The system 100 includes an HMI controller 102 coupled to a number of HMI components, including a haptics interface 104, an Audio interface 106, a Head-Up Display (HUD) 108, an instrument cluster 110, and a center stack 112.

The haptics interface 104 includes one or more systems configured to provide user feedback through the sense of touch. For example, the haptics interface may be configured to control a vibration mechanism coupled to the driver's seat or steering wheel. Vibrations may be delivered to the user through the vibration mechanism to alert the driver or arouse the driver's attention.

The audio interface 106 can include a speaker system distributed throughout the vehicle. The audio interface 106 may be controlled to deliver any type of audio to the driver, including audio alerts, verbal instructions, music from a media player, an audio broadcast from a radio station, and others.

The HUD 108 can be configured to deliver any suitable type of data to a user by projecting the data onto the windshield of the vehicle. For example, data displayed on the HUD may include navigation data, vehicle instrument data, driver alerts, and others.

The instrument cluster 110 is configured to display data about the vehicle and can include a speedometer, tachometer, odometer, fuel gauge, warning lights, indicators lights, and the like. The instrument cluster 110 may be located in the vehicle dashboard behind the steering wheel, for example.

The center stack 112 is a user interface that usually resides in or near the dashboard at the center between the driver and passenger seats. The center stack may include various user controls and display screens, including controls for the vehicle environmental systems such as heating and air conditioning systems, controls for the media systems such as the AM, FM, and satellite radio systems, controls and a display screen for the vehicle navigation, and others.

The HMI controller 102 controls the delivery of data to the various HMI components 104-112. The HMI controller 102 may receive data from a variety of sources. For example, the HMI controller 102 may receive some data from an antenna subsystem 114. Through the antenna subsystem 114, the HMI controller 102 may receive radio broadcasts including AM, FM, or satellite radio, cellular phone calls and data, Global Positioning System (GPS) data, and others. Through the antenna subsystem 114, the HMI controller 102 may be able to communicate with one or more service providers 116 through the Internet. Examples of services include navigation, media, emergency assistance, and others.

The system 100 may also include an Advanced Driver Assistance System (ADAS) 118. The ADAS system 118 includes sub systems that are able to control some aspect of the vehicle to enhance driver control and/or safety. Examples of ADAS systems include automatic parking, collision warning, blind spot monitoring, driver drowsiness detection, collision avoidance, and others. The ADAS 118 can receive data from any number of different types of sensors to determine vehicle driving conditions, environmental conditions, and the like. As used herein, the term sensor includes any device that enables the ADAS or other system in the vehicle to acquire information about the vehicle, the driver, or the environment inside of or outside of the vehicle. Examples of such sensors include cameras, radar systems, laser systems, antennas, temperature sensors, and others.

The ADAS 118 can acquire data about the environment around the vehicle from the antenna subsystem 114. For example, the antenna subsystem may receive data transmission from other vehicles on the road (vehicle-to-vehicle communications) and from infrastructural roadside transmissions (vehicle-to-infrastructure communications). Such transmission from the infrastructure and from other vehicles may be include information regarding road hazards, maneuvers being performed by another vehicle such as lane changes, and other data. The ADAS 118 can process the various data received to identify an action to be performed. The action may include initiating a driving maneuver such as application of the brakes, reducing speed, or issuing an alert to the driver, for example.

The system also includes a Situational Awareness Monitor (SAM) 120. The SAM 120 monitors various aspects of the vehicle conditions, driving conditions, driver conditions, or any other information that relates to the driver's effectiveness, safety, and enjoyment. The SAM 120 can perform driver monitoring, vehicle monitoring, vehicular environment monitoring, and the like. The SAM 120 may be configured to receive data from the ADAS 118. The data from the ADAS 118 may be raw sensor data received by the ADAS and passed through to the SAM 120 for additional processing. The data from the ADAS 118 can also include processed data relating to an action identified and/or performed by the ADAS 118 based on the processing of the sensor data received by the ADAS 118. Communication between the ADAS and the SAM 120 may be accomplished through a vehicle data bus such as a controller area network (CAN) bus. In some instances, the data received from the ADAS 118 is related to an identified driver alert condition that is to be communicated to the driver through the SAM 120.

The SAM 120 may also receive data about driver, vehicle, or environmental conditions from the HMI controller 102. For example, the SAM 120 may receive GPS data vehicle-to-vehicle transmissions, and vehicle-to-infrastructure transmissions from the antenna subsystem 114 through the HMI controller 102. Video acquired by the ADAS 118 can be sent to the HMI controller 102 to be rendered by one or more of the HMI components 104 to 112. For example, a video feed received by the ADAS 118 from a backup camera can be rendered on a video display of the center stack 112. Video acquired by the ADAS 118 can also be sent to the SAM 120 for additional processing. For example, a video feed of the driver's face may be captured by a video camera inside the vehicle cabin and received by the SAM 120 for processing to determine a driver's condition, such as whether the driver is drowsy or inattentive. The SAM 120 can also receive information from additional devices not shown in FIG. 1, including additional sensors and/or processors.

The SAM 120 processes the received data to determine a driving conditions status. The driving conditions status may relate to any aspect of the driving conditions including a status of the driver, a status of the vehicle, a condition of the internal environment inside the vehicle, or external environment outside of the vehicle, among others. The driving conditions status is communicated to the HMI controller 102 using a predefined protocol. The predefined protocol may be a standardized protocol that can be interpreted by many or all of the software subsystems that reside on the HMI controller 102.

The HMI controller 102 may act on the driving conditions status received from the SAM 120 in accordance with programming. One or several of the HMI components 104 to 112 may be triggered to take some action based on the driving conditions status received from the SAM 120. Accordingly, safety systems such as those included in the AD AS 118 are integrated with other functions of the vehicle such as the radio, navigation system, and instrument cluster. In this way, data can be presented to the user in a more integrated and contextually aware presentation that optimizes the driver's ability to deal with the information while maintaining safe driving.

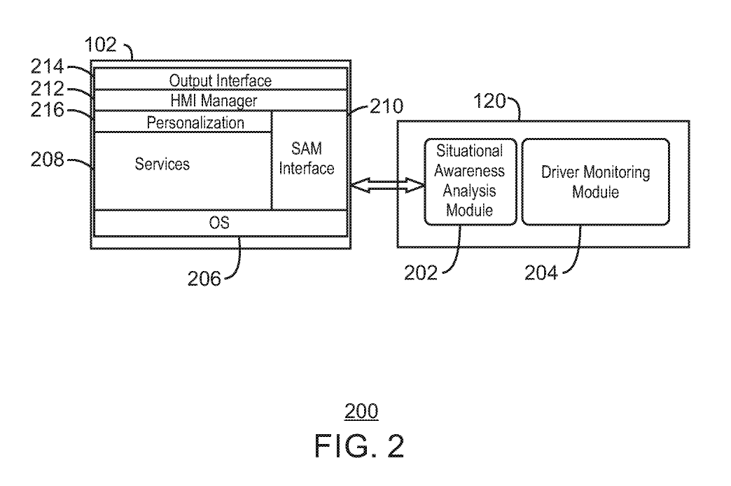

FIG. 2 is a block diagram of an HMI controller 102 in communication with the SAM 120. As shown in FIG. 2, the SAM 120 can include a situational awareness analysis module 202 and a driver monitoring module 204. The driver monitoring module 204 can monitor various aspects of the driver using data from a variety of sensors in the vehicle. For example, the analysis of the driver may be based on a video stream of the driver's face and/or body captured by a camera. The driver analysis may also be based on data acquired from biometric sensors that measure breathing rate, pulse rate, and the like. The driver analysis may also be based on data acquired from a microphone or the steering wheel.

The driver monitoring module 204 processes the received data to determine a driver status and reports the driver status to the situational awareness analysis module 202. The driver status may indicate, for example, that the driver is drowsy or has fallen asleep, that the driver is distracted or unable to see a particular hazard, that the driver is suffering some sort of medical event, or any other relevant condition of the driver. The SAM 120 can report the driver status to the HMI 102. In some examples, the situation awareness analysis module 202 uses the driver status as one input in generating a comprehensive driving conditions status.

The situational awareness analysis module 202 can receive input from the various components and sensors through the vehicle such as the ADAS 118, video feeds from cameras, the HMI controller 102, and others. The situational awareness analysis module 202 processes the received data to generate the driving conditions status and transmit the driving conditions status to the HMI controller 102.

The HMI controller 102 can include an operating system (OS) 206, software services 208, a SAM interface, HMI manager 212, and an output interface 214. The software services include the programming for the various services provided in the vehicle. For example, the services can include media services, navigation, networking services, external data services, climate control, and others. The SAM interface 210 receives the driving condition status from the situational awareness analysis module 202 and makes the driving conditions status available to the HMI manager 212 and the services 208. The driving conditions status may b e formatted according to a specified communication protocol that may be interpreted by all of the services 208.

The HMI manager 212 receives data from the services 208 and generates HMI output for the HMI components 104-112 based on the data. The HMI manager 212 communicates with each of the HMI components through the output interface 214. The HMI manager 212 can prioritize information being received from different services and determine what output to deliver to the HMI components 104-112 (FIG. 1). For example, music audio may be generated by a multimedia service for delivery to the audio system 106. The HMI manager 22 may determine that the music audio should be delivered to the audio system until another service attempts to take control of the audio system with higher priority data, such as a user alert.

The HMI manager 212 can also receive data from the SAM interface 210 and generate HMI output based in part on the driving condition status. For example, if the driving condition status indicates the presence of a road hazard, the HMI manager 212 may generate a user warning in the form of audio that can be delivered to the audio system 106, visual data that can be sent to the HUD 108, and other types of data. Because the services 208 and the HMI manager 212 have access to the driving condition status information, the output sent to each of the HMI components 104-112 can be coordinated in response to the same driving conditions status. This enables a more context-relevant control of the information communicated to the driver.

In some examples, the HMI controller 102 also includes a personalization module. The personalization module 216 enables services to be personalized for individual drivers. The personalization module 216 can use adaptive learning to generate a profile for individual drivers and customize the services accordingly. The personalization module 216 can also receive the driving conditions status information from the SAM interface 210. In this way, the responses to various driving conditions may be personalized to each driver.

The HMI controller 102 and the SAM 120 may be implemented in hardware or a combination of hardware and programming. In some examples, the HMI controller 102 and the SAM 120 may be separate processors. In some examples, the SAM 120 may be implemented as a code module within the HMI controller 102.

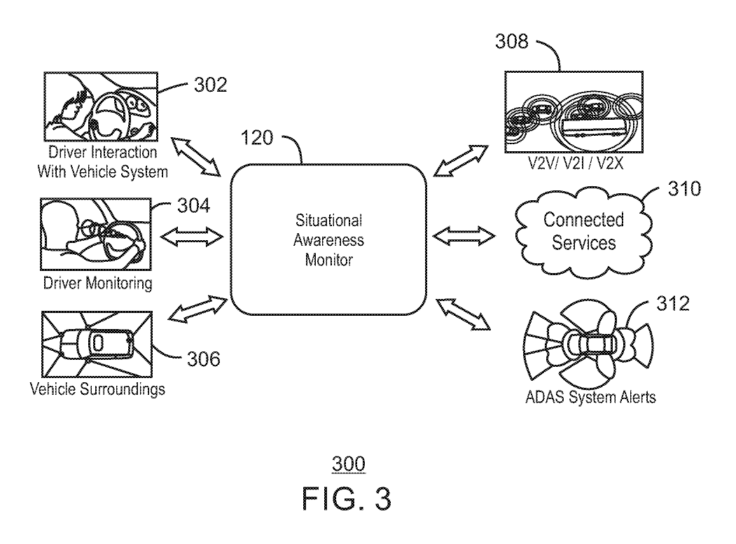

FIG. 3 is a diagram of the SAM showing the various types of driving condition information that may be collected and processed by the SAM. The SAM 120 may receive driver interaction information 302 that describes the driver interaction with the vehicle controls including the steering wheel, accelerator, brakes, blinkers, climate control, radio, and others. This information may be used as an indication of a driver's state of mind. For example, extended interaction with the radio controls during vehicle movement may indicate that the driver is distracted.

The SAM 120 may receive information from a driver monitoring system 304.

Information from the driver monitoring system 304 may include an indication of a driver's level of alertness or area of focus. For example, a camera image of the driver's face may be received and an image of the driver's eyes processed to determine whether the driver is drowsy. The driver monitoring system 304 can also receive information from microphones, pulse monitors, and other sensors.

The SAM 120 may receive information from vehicle surroundings sensors 306. The vehicle surrounding sensors 306 may be used to indicate that an object is in the vehicle blind spot, or that an object is behind the vehicle while backing up. The vehicle surrounding sensors 306 can also be used to indicate the presence of automobiles or other objects in front of the vehicle.

The SAM 120 may receive information from a vehicle-to-vehicle (V2V), vehicle to-infrastructure (V2I), and vehicle-to-everything (V2X) communications 308. The V2V, V2I, and V2X communications enable the vehicle to communicate with other vehicles or objects in the vicinity of the vehicle. Information received through these communications can include traffic conditions, weather, conditions affecting safety, lane change warnings, travel related information, advertising, and other information.

The SAM 120 can also receive data from connected services 310. The connected services can include substantially any service that can be provided over a network such as the Internet. Connected services may include media services, entertainment, roadside assistance, social media, navigation, and other types of data.

The SAM 120 can also receive alerts and other data from the vehicles ADAS system 312. The ADAS system can provide information about safety issues detected by the vehicle, including blind spot detection, collision avoidance alerts, emergency braking, and others.

All of the information collected by the SAM 120 can be processed to generate a comprehensive driving conditions status that takes into account all of the available information about the vehicle, the driver, and the vehicle's surroundings. The comprehensive driving conditions status is used by the HMI controller, which has access to most or all of the vehicle's driver interface components. The techniques described herein enable all of the information available throughout the vehicle to be analyzed to generate the driving conditions status, which results in a more comprehensive indicator of the overall driving conditions. The centralized processing of the driving conditions also enables prioritization of more important driving condition factors and more effective use of the HMI components to communicate important information to the driver.

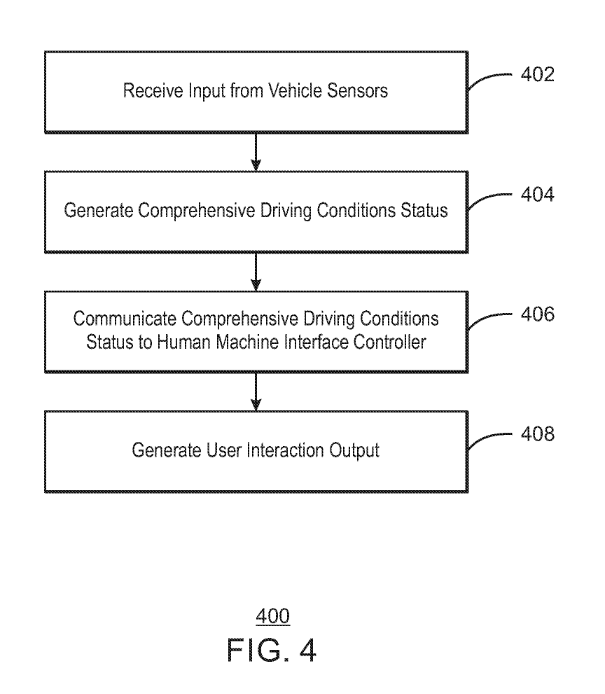

FIG. 4 is a process flow diagram summarizing an example method 400 for an interaction system to operate for a vehicle. Process flow begins at block 402. The method 400 may be performed by a component of a vehicle such as the Situation Awareness Monitor 120, the HMI controller 102, or some combination thereof.

At block 402, input is received from vehicle sensors for monitoring driver and vehicle conditions. The vehicle sensors include any type of sensor or system that can generate information useful for monitoring a driver, a vehicle, or conditions inside or outside the vehicle. For example, the sensors may include a camera, an ADAS system, and others.

At block 404, a comprehensive driving conditions status is generated based on the input. The driving conditions status is comprehensive because it takes into account a wide variety of information available from various systems throughout the vehicle.

At block 406, the comprehensive driving conditions status is communicated to a human machine interface controller using a specified protocol. The human machine interface controller is coupled to a plurality of interface components of the vehicle.

At block 408, the human machine interface controller uses the comprehensive driving conditions status to help determine an appropriate user interaction out based in part on the driving conditions.

While the invention may be susceptible to various modifications and alternative forms, specific embodiments have been shown by way of example in the drawings and will be described in detail herein. However, it should be understood that the invention is not intended to be limited to the particular forms disclosed. Rather, the invention is to cover all modifications, equivalents and alternatives falling within the spirit and scope of the invention as defined by the following appended claims.

What is claimed is:

1. An interaction system for a vehicle, comprising:
a human machine interface controller coupled to a plurality of interface components of the vehicle that communicate information to a driver of the vehicle; and
a situational awareness module coupled to the human machine interface controller, the situational awareness module to:
monitor driver conditions and vehicle conditions;
generate a comprehensive driving conditions status; and
communicate the comprehensive driving conditions status to the human machine interface controller using a specified protocol.

2. The interaction system of claim 1, wherein the situational awareness module receives input from an Advanced Driver Assistance System of the vehicle to generate the comprehensive driving conditions status.

3. The interaction system of claim 1, wherein the situational awareness module receives input from one or more sensors configured to monitor a driver of the vehicle to generate the comprehensive driving conditions status.

4. The interaction system of claim 1, wherein the situational awareness module receives input from an antenna subsystem of the vehicle to generate the comprehensive driving conditions status.

5. The interaction system of claim 1, wherein the situational awareness module receives input about the vehicle's surroundings to generate the comprehensive driving conditions status.

6. The interaction system of claim 1, wherein the human machine interface controller comprises an interface that receives the comprehensive driving conditions status from the situational awareness module and makes the comprehensive driving conditions status available to a plurality of software services operating on the human machine interface controller.

7. The interaction system of claim 1, wherein the human machine interface controller comprises a personalization service that receives the comprehensive driving conditions status and wherein an output of the human machine interface controller is customized to a particular driver based in part on the comprehensive driving conditions status.

8. A method for user and vehicle interaction, comprising:
receiving input from vehicle sensors for monitoring driver conditions and vehicle conditions;
generating a comprehensive driving conditions status based on the input;
communicating the comprehensive driving conditions status to a human machine interface controller using a specified protocol, wherein the human machine interface controller is coupled to a plurality of interface components of the vehicle that communicate information to a driver of the vehicle; and
generating a user interaction output at the human machine interface controller based in part on the comprehensive driving conditions status.

9. The method of claim 8, wherein generating the comprehensive driving conditions status comprises receiving input from an Advanced Driver Assistance System.

10. The method of claim 8, wherein generating the comprehensive driving conditions status comprises receiving input from one or more sensors configured to monitor a driver of the vehicle.

11. The method of claim 8, wherein generating the comprehensive driving conditions status comprises receiving input from an antenna subsystem of the vehicle.

12. The method of claim 8, wherein generating the comprehensive driving conditions status comprises receiving input about the vehicle's surroundings to generate the comprehensive driving conditions status.

13. The method of claim 8, comprising receiving the comprehensive driving conditions status at the human machine interface controller and making the comprehensive driving conditions status available to a plurality of software services operating on the human machine interface controller.

14. The method of claim 8, comprising receiving the comprehensive driving conditions status at a personalization service and customizing the user interaction output to a particular driver based in part on the comprehensive driving conditions status.

15. A vehicle for interaction with a user comprising:
an ignition system;
a plurality of sensors to acquire data about driver conditions and vehicle conditions; and
a processor to:
monitor the driver conditions and the vehicle conditions based on the data acquired by the sensors;
generate a comprehensive driving conditions status based on the monitoring; and
communicate the comprehensive driving conditions status to a human machine interface controller using a specified protocol, wherein the human machine interface controller is coupled to a plurality of interface components of the vehicle that communicate information to the driver of the vehicle.

16. The vehicle of claim 15, where into monitor the driver conditions and the vehicle conditions, the processor is to receive input from an Advanced Driver Assistance System of the vehicle.

17. The vehicle of claim 15, where into monitor the driver conditions and the vehicle conditions, the processor is to receive input from one or more sensors configured to monitor the driver of the vehicle.

18. The vehicle of claim 15, wherein to monitor the driver conditions and the vehicle conditions, the processor is to receive input from an antenna subsystem of the vehicle to generate the comprehensive driving conditions status.

19. The vehicle of claim 15, where into monitor the driver conditions and the vehicle conditions, the processor is to receive input about the vehicle's surroundings to generate the comprehensive driving conditions status.

20. The vehicle of claim 15, wherein the human machine interface controller comprises an interface that receives the comprehensive driving conditions status and makes the comprehensive driving conditions status available to a plurality of software services operating on the human machine interface controller.
